(19) United States
(12) Patent Application Publication
(10) Pub. No.: US 2009/0135171 A1
(43) Pub. Date: May 28, 2009

(54) VOLTAGE GENERATING SYSTEM

(75) Inventors: Po-Tsun Chen, Hsinchu County (TW); Kai-I Dai, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/968,652

(22) Filed: Jan. 3, 2008

(30) Foreign Application Priority Data
Nov. 23, 2007 (TW) 96144423

(51) Int. Cl. G09G 5/00

(52) U.S. Cl. 345/211

(57) ABSTRACT

A voltage generating system applied to a display driving apparatus is disclosed, which is capable of changing a time point at which a signal of a pixel electrode and a signal of a common electrode perform polarity inversion, so as to adjust the frequency of an AC common voltage dynamically. Therefore, the noise frequency caused by the transition of the AC common voltage is dispersed, and the energy of audio-frequency noises and high-frequency noises is reduced.

### CROSS-REFERENCE TO RELATED APPLICATION

This application claims the priority benefit of Taiwan application serial no. 96144423, filed on Nov. 23, 2007. The entirety of the above-mentioned patent application is hereby incorporated by reference herein and made a part of this specification.

### BACKGROUND OF THE INVENTION

1. Field of the Invention

The present invention generally relates to a voltage generating system, in particular, to a voltage generating system applicable for a liquid crystal display (LCD).

2. Description of Related Art

In recent years, along with the booming of semiconductor technology, even the portable electronics and flat panel display products have been developed vigorously. Among all kinds of flat panel displays, the LCD has become the main stream of the display products due to the advantages of low-voltage operation, no radiation scattering, low weight, small volume, and so on. Thanks to the same reason, small-size LCD panels have generally been disposed in digital cameras, so that the pictures already taken or pictures to be shot can be shown to the user at a real time.

As well-known that, if a constant bias is applied on pixels in the LCD panel for a long time, the liquid crystal molecules of pixels may be polarized. In order to solve the problem, in LCD panel, a polarity inversion is generally performed between the signal of a pixel electrode and the signal of a common electrode, thereby effectively eliminating the polarization of liquid crystal molecules. Moreover, in a small-size LCD panel, in order to facilitate the above operation, the generated common voltage is an AC common voltage, which serves as a voltage difference between the pixel electrode and the common electrode.

FIG. 1 is a schematic view of a conventional voltage generating system 100. As shown in FIG. 1, a clock generator 121 in a timing controller 120 is used to provide a clock signal CLK, and the AC common voltage generating circuit 110 generates an AC common voltage VCOM according to the clock signal CLK.

However, in the conventional art, the clock signal CLK is a clock signal having a fixed frequency. Moreover, in order to conform to the picture display features, the fixed frequency falls within the audio frequency range (about 20 Hz-20 KHz). Therefore, the AC common voltage VCOM generated according to the clock signal CLK may have a large energy at the fixed frequency, and thus generating audio-frequency noises (i.e., noises of 20 Hz-20 KHz) that can be heard by human beings.

Moreover, as known in this field, the charge-pump circuit is a power device for supplying power to the LCD or driving IC. However, the charge-pump circuit may have the same trouble. Referring to FIG. 1, as shown in FIG. 1, the charge-pump circuit 130 generates a predetermined voltage Vg according to the clock signal CLK. For example, a plurality of switches is disposed within the charge-pump circuit 130, and the states of these switches are changed according to the clock signal CLK, so as to decide the charging/discharging operation of the charge-pump circuit 130, and to further generate a predetermined voltage Vg. Likewise, the states of the switches are also switched according to the clock signal CLK, and thus introduce the problem of the audio-frequency noises as well.

### SUMMARY OF THE INVENTION

Accordingly, the present invention is directed to a voltage generating system applicable for a display driving apparatus (display device), which changes a time point at which a signal of a pixel electrode and a signal of a common electrode perform polarity inversion, so as to dynamically adjust a frequency of an AC common voltage, and thus reducing the energy of audio-frequency noises.

Moreover, the present invention is directed to a voltage generating system applicable for a display driving apparatus, which changes a transition point for an internal switching signal of a charge-pump circuit, so as to adjust a frequency of the internal switching signal dynamically, and thus reducing the energy of audio-frequency noises.

The present invention is directed to a voltage generating system applicable for a display driving apparatus, which includes an AC common voltage generating circuit and a first control unit. The first control unit is used to generate a first control signal and to change at least one time point at which the first control signal performs transition, so as to adjust a frequency of the first control signal dynamically. The AC common voltage generating circuit is coupled to the first control unit. Moreover, the AC common voltage generating circuit generates an AC common voltage according to the first control signal.

According to an embodiment of the present invention, when the display driving apparatus is in a vertical active region, the time point at which the AC common voltage performs transition is limited within an energy dissipation region of a scan line.

According to an embodiment of the present invention, when the display driving apparatus is in a vertical blanking region, the time point at which the AC common voltage performs transition may be changed arbitrarily.

According to an embodiment of the present invention, the first control unit generates a first control signal according to a sequence.

According to an embodiment of the present invention, the present invention further includes a sequence generator coupled to the first control unit for generating the sequence.

According to an embodiment of the present invention, the sequence is a random number sequence, and the sequence generator is a random number sequence generator.

According to an embodiment of the present invention, the sequence is formed by a plurality of code signals. Any one code signal in the plurality of code signals includes a direction bit and at least one time bit. The first control unit delays or advances the above time points for the transition according to the direction bit, and decides the extent to which the time points for the transition are delayed or advanced according to the time bit in the code signal. Alternatively, the code signal may be considered as merely formed by time bits, and the extent to which the time points for the transition are delayed is decided according to the time bits from the very beginning of the code signal.

According to an embodiment of the present invention, when the display driving apparatus is in a vertical active region, a code signal outputted by the random number sequence generator has a first bit number. When the display driving apparatus is in a vertical blanking region, a code signal outputted by the random number sequence generator has a second bit number larger than the first bit number.

According to an embodiment of the present invention, the first control unit and the sequence generator are disposed in a timing controller.

According to an embodiment of the present invention, the voltage generating system further includes a charge-pump circuit. The charge-pump circuit is coupled to the first control unit and used to generate a predetermined voltage according to the first control signal.

According to an embodiment of the present invention, the first control unit is also used to generate a second control signal. The voltage generating system further includes a charge-pump circuit. The charge-pump circuit is coupled to the first control unit and used to generate a predetermined voltage according to the second control signal.

According to an embodiment of the present invention, the first control unit changes at least one time point at which the second control signal performs transition, so as to adjust a frequency of the second control signal dynamically.

According to an embodiment of the present invention, the voltage generating system further includes a second control unit for generating the second control signal, and a charge-pump circuit. The second control unit changes at least one time point at which the second control signal performs transition, so as to adjust the frequency of the second control signal dynamically. The charge-pump circuit is coupled to the second control unit and used to generate a predetermined voltage according to the second control signal.

According to an embodiment of the present invention, in the voltage generating system, the second control signal is generated by shifting a phase of the first control signal.

According to an embodiment of the present invention, in the voltage generating system, the first control unit and the second control unit may be turned on or off individually.

According to an embodiment of the present invention, the first control unit and the second control unit are disposed in a timing controller.

The present invention is also directed to a voltage generating system applicable for a display driving apparatus, which includes a control unit and a charge-pump circuit. The control unit is used to generate a control signal. The charge-pump circuit is coupled to the control unit and used to generate a predetermined voltage to pixels of the display driving apparatus. According to the control signal, the charge-pump circuit changes the time point at which an internal switching signal thereof for generating a predetermined voltage performs transition, so as to adjust the frequency of the switching signal dynamically.

In the display driving apparatus and method thereof provided in the present invention, a time point at which a signal of a pixel electrode and a signal of a common electrode perform polarity inversion is changed to adjust the frequency of an AC common voltage dynamically. Therefore, the noise frequency caused by the transition of the AC common voltage is dispersed, thereby effectively reducing the energy of audio-frequency noises and high-frequency noises.

Based on the above, when a digital camera using the display driving apparatus and method provided in the present invention is applied for video recording, since the audio-frequency noises produced by the digital camera itself can be effectively suppressed, thus the recorded sounds do not have noises. Furthermore, the LCD using the display driving apparatus and method provided in the present invention may also effectively reduce the electromagnetic interference index of its own.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional voltage generating system 100.

FIG. 2 is a block diagram of a voltage generating system 200 according to a first embodiment of the present invention.

FIG. 3 is a driving timing diagram of a display driving apparatus.

FIG. 4 is a timing diagram of an AC common voltage VCOM in a vertical active region according to the present invention.

FIG. 5 is a timing diagram of an AC common voltage VCOM in a vertical blanking region.

FIG. 6 is a schematic view of a 4/7 bit linear feedback shift register (LFSR) 600 according to an embodiment of the present invention.

FIG. 7 is a block diagram of a voltage generating system according to a second embodiment of the present invention.

FIG. 8 is a block diagram of a voltage generating system according to a third embodiment of the present invention.

FIG. 9 is a block diagram of a voltage generating system according to a fourth embodiment of the present invention.

FIG. 10 is a block diagram of a voltage generating system according to a fifth embodiment of the present invention.

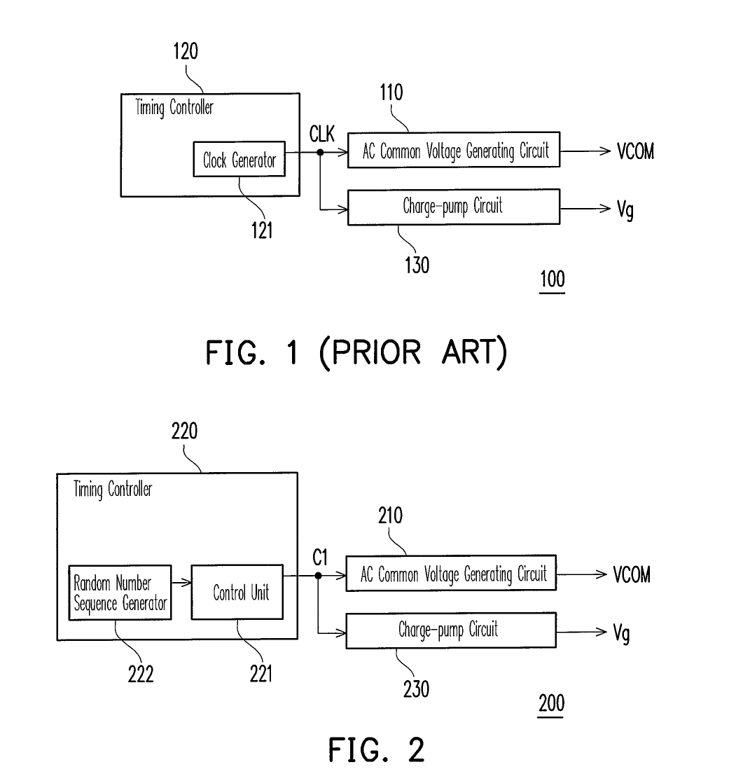

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention mainly aims at reducing the audio-frequency noises and high-frequency noises caused by the polarity inversion between the signal of a pixel electrode and the signal of a common electrode. Hereinafter the technical effect of the present invention is illustrated in detail, which is provided for the reference of persons of ordinary skill in the art.

FIG. 2 is a block diagram of a voltage generating system 200 according to a first embodiment of the present invention. Referring to FIG. 2, the voltage generating system 200 includes an AC common voltage generating circuit 210, a timing controller 220, and a charge-pump circuit 230. The timing controller 220 includes a control unit 221 and a random number sequence generator 222.

In this embodiment, when an LCD (not shown) is turned on, the AC common voltage generating circuit 210 generates an AC common voltage VCOM according to a control signal C1 generated by the control unit 221, for being used by pixels on the LCD panel. It should be noted that, the control signal C1 is a signal having different periods, instead of a clock signal having a constant frequency. Therefore, the AC common voltage VCOM generated according to the control signal C1 may reduce the audio-frequency noises.

In this embodiment, the control unit 221 generates the control signal C1 according to the random number sequence generated by the random number sequence generator 222. For example, the control unit 221 dynamically changes a transition point of the control signal C1, so as to adjust the frequency of the control signal C1 dynamically. In this way, the AC common voltage VCOM generated according to the control signal C1 may correspondingly change the time point for the transition (equivalent to dynamically adjusting the frequency of the AC common voltage VCOM). In this embodiment, the charge-pump circuit 230 also generates a predetermined voltage Vg internally required by the display according to the control signal C1.

It should be noted that, the AC common voltage VCOM is generated in substantially the same way as the internal switching voltage used by the charge-pump circuit 230 for generating the predetermined voltage Vg. For simplicity, only the way for generating the AC common voltage VCOM and the time sequence thereof in the present invention are illustrated hereinafter.

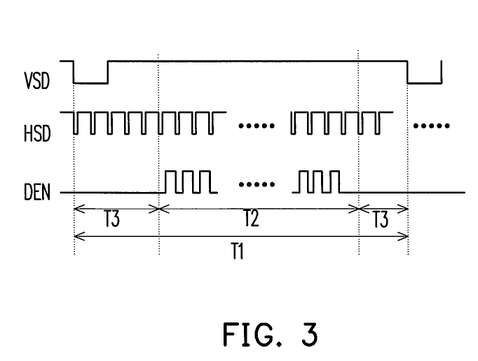

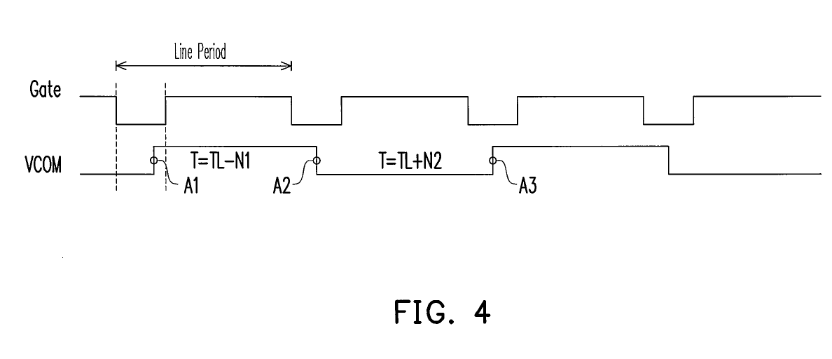

It should be noted that, in the driving timing of the display driving apparatus, a complete frame period includes a vertical active region and a vertical blanking region. FIG. 3 is a driving timing diagram of a display driving apparatus. As shown in FIG. 3, a frame period T1 starts from a time point at which a vertical synchronization signal VSD performs a transition from 1 to 0, and ends at a time point at which the vertical synchronization signal performs the next transition from 1 to 0. One frame period T1 includes a lot of line scan operations, and each transition of a parallel synchronization signal HSD from 1 to 0 indicates the occurrence of one line scan operation. A data output enabling signal DEN indicates that data will be sent to the display panel, that is, when the data output enabling signal DEN is 1, pixels of the display panel are driven.

Referring to the timing of the signal in FIG. 3, when the vertical synchronization signal VSD performs an transition from 1 to 0, the frame period T1 starts, and the line scan operation is performed simultaneously (the parallel synchronization signal HSD starts to perform transitions from 1 to 0 and then 0 to 1 over and over again). It may be known from the illustration in the above paragraph that, each transition of the parallel synchronization signal HSD from 1 to 0 indicates one line scan operation. When the first several line scan operations when the frame period T1 just begins are performed, the data output enabling signal DEN has not ever been enabled, and remained at 0. Moreover, when the last several line scan operations at the end of the frame period T1 are performed, the data output enabling signal DEN is also not enabled, and still remained at 0. The two regions where the data output enabling signal DEN is not enabled are called a vertical blanking region T3. In contrast, the region where the data output enabling signal DEN is enabled is called a vertical active region T2.

It should be noted that, in an embodiment of the present invention, the control signal C1 has different limitations in the vertical blanking region from that in the vertical active region, and thus the extent for the frequency adjustment is different from each other as well.

Referring to FIGS. 2 and 3, it should be noted that, when the voltage generating system 200 is in the vertical active region T2, the time point at which the AC common voltage VCOM (the control signal C1) performs transition should fall within an energy dissipation region of scan line, which is a gate-off region. The reason for the limitation lies in, since the display lights up the pixels at the vertical active region T2, the picture may flicker if the AC common voltage VCOM performs transition in the gate-on region. Therefore, in an embodiment of the present invention, the AC common voltage VCOM performs transition in the gate-off region, and at this time, the gate is in the off state, and thus the picture can be prevented from being affected or flickering.

On the other hand, when the voltage generating system 200 is in a vertical blanking region T3, since the pixels of the panel are not driven, the time point at which the AC common voltage VCOM performs transition is not limited by the above factors, but may fall within any region arbitrarily.

FIG. 4 is a timing diagram of an AC common voltage VCOM (the control signal C1) in a vertical active region according to the present invention. In FIG. 4, the gate signal Gate at Level 1 indicates that the gate is turned on, which is the so-called gate-on region; the gate signal Gate at Level 0 indicates that the gate is off, which is the so-called gate-off region. As mentioned above, in order to prevent the picture from being affected or flickering, the transition point A1, the transition point A2, and the transition point A3 for the AC common voltage VCOM (the control signal C1) are all controlled in the gate-off region. However, it should be noted that, the time point for the AC common voltage VCOM to perform transition is different in each time. Herein, if it is assumed that the original period of the AC common voltage VCOM (the control signal C1) is TL, the control unit 221 decides the extent to which the period (or position of the transition point) is changed during each transition according to the random number sequence generated by the random number sequence generator 222. For example, during the first transition (the transition point A1), the period (or the position of transition point) is changed from the original TL into TL-N1.

In other words, the present invention is capable of dynamically adjusting the frequency of the AC common voltage VCOM, such that the energy for the transition of the AC common voltage VCOM may not be concentrated at a specific frequency. Therefore, the problem of the audio-frequency noises caused by the AC common voltage VCOM may be solved.

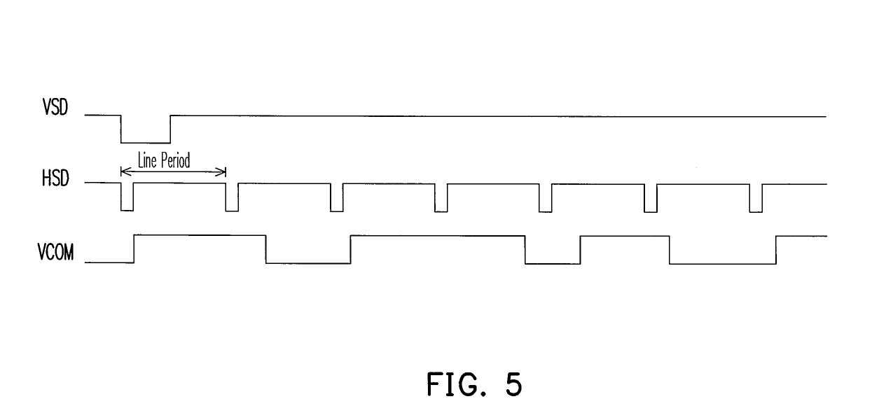

FIG. 5 is a timing diagram of an AC common voltage VCOM (the control signal C1) in a vertical blanking region. In FIG. 5, the display is in the vertical blanking region, and as mentioned above, the pixels of the panel are not driven at this time, the transition point for the AC common voltage VCOM may fall within any region arbitrarily, not being merely limited in the gate-off regions. As shown in FIG. 5, the frequency of the AC common voltage VCOM is also dynamically adjusted continuously, and due to the larger adjustable range for the period of the AC common voltage VCOM (position of the transition point), the transition energy for the AC common voltage VCOM is dispersed into a broader frequency band, such that the noises are more significantly reduced.

In practice, the above mechanism is not difficult for persons of ordinary skill in the art. Referring to FIG. 2, as mentioned above, the random number sequence generator 222 is used to generate a random number sequence. In this embodiment, the random number sequence is formed by a continuously changed multiple-bit code, which may be considered as a combination of a one-bit direction bit and multiple-bit time bits. The direction bit is used for delaying or advancing the time point at which the AC common voltage VCOM performs transition. The time bits are used to decide the extent to which the time point for the transition of the AC common voltage VCOM is delayed or advanced. Moreover, the random number sequence may also be merely considered as a combination of several-bit time bits, for deciding the extent to which the time point for the transition of the AC common voltage VCOM is delayed.

Referring to FIG. 4, the time interval T between each transition point of the AC common voltage VCOM is changed all the time. The time interval between the transition point A1 and the transition point A2 shown in FIG. 4 equals to the result of subtracting an adjustment value N1 from a line period TL. The subtracting calculation of the time indicates that the time point for the transition of the AC common voltage VCOM is advanced, that is, controlled by the direction bit. The adjustment value N1 is the extent for advancing the time point, which is decided by the time bit. In another example, the time interval between the transition point A2 and the transition point A3 equals to the line period TL added with an adjustment value N2. The adding calculation of the time indicates that the time point for transition of the AC common voltage VCOM is delayed, and the adjustment value N2 is the extent for delaying the time point, which is decided by the time bit.

It should be noted that, generally, an ideal random number sequence is unpredictable, and the occurrence frequency for each random number shall be the same. Therefore, through adopting the random number sequence, the time point for the transition of the AC common voltage VCOM is evenly changed, such that the noises caused by the transition of the AC common voltage VCOM is effectively dispersed at different frequencies, so as to optimize the effect of reducing the noises. For example, if the code sequence has k types of different random numbers, the noises caused by the transition of the AC common voltage VCOM will be theoretically dispersed into k types of different frequencies, so as to reduce the audio-frequency noises.

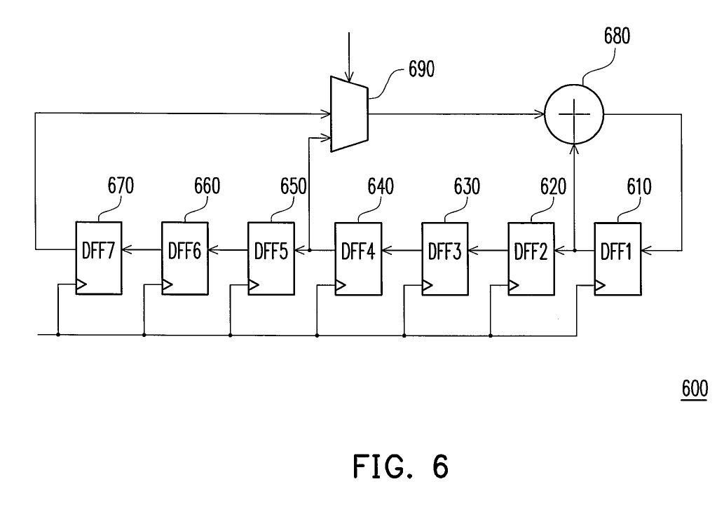

Therefore, in this embodiment, the present invention adopts a linear feedback shift register (LFSR) to serve as a random number generator 222. FIG. 6 is a schematic view of a 4/7 bit linear feedback shift register (LFSR) 600 according to an embodiment of the present invention. As shown in FIG. 6, the LFSR 600 is formed by seven shift registers 610-670, an XOR gate 680, and a multiplexer 690. Herein, the functions and operations of the LFSR 600 are well known and thus omitted here. However, it should be noted that, the multiplexer 690 is used to decide the signal fed back to the XOR gate 680. For example, if it is intended to merely generate a 4-bit random number sequence, the multiplexer 690 selects the signal outputted by the shift register 640 as a feedback signal. On the other hand, if it is intended to generate a 7-bit random number sequence, the multiplexer 690 selects the signal outputted by the shift register 670 as a feedback signal.

Such an architecture is adopted to cooperate with the above mechanism. As mentioned above, in the vertical active region, since the transition point for the AC common voltage VCOM preferably falls within the gate-off region, the generated random number sequence must have a small bit number, such that the time point for the transition of the AC common voltage VCOM (the control signal C1) has a relatively small deviation. Therefore, in this embodiment, when the display is in the vertical active region, the multiplexer 690 selects the signal outputted by the shift register 640 as a feedback signal, so as to output a 4-bit random number sequence. On the other hand, when the display is in the vertical blanking region, since the transition point for the AC common voltage VCOM may fall within any position arbitrarily, a random number sequence having a relatively large bit number may be adopted. Therefore, in this embodiment, when the display is in the vertical blanking region, the multiplexer 690 selects the signal outputted by the shift register 670 as a feedback signal, so as to output a 7-bit random number sequence.

It should be noted here that, the LFSR 600 is merely one embodiment of the random number generator, but not to limit thereby. In practice, person skilled in the art may use other kinds of random number generators. Moreover, the number of the shift registers in the LFSR 600 is also not limited as well, persons skilled in the art may use more or less shift registers, and such corresponding variations still fall within the scope of the present invention.

Moreover, although a random number sequence is taken as the basis for generating the control signal in the above disclosure, but the architecture is not used to limit the present invention. The reason for using the random number sequence lies in that, the random number sequence may reach a certain random degree, which thus enables the energy to be more evenly dispersed at different frequencies. However, in practical applications, persons skilled in the art may use a fixed sequence (such as a periodical sequence) to dynamically adjust the frequency of the AC common voltage; and such corresponding variation also falls within the scope of the present invention.

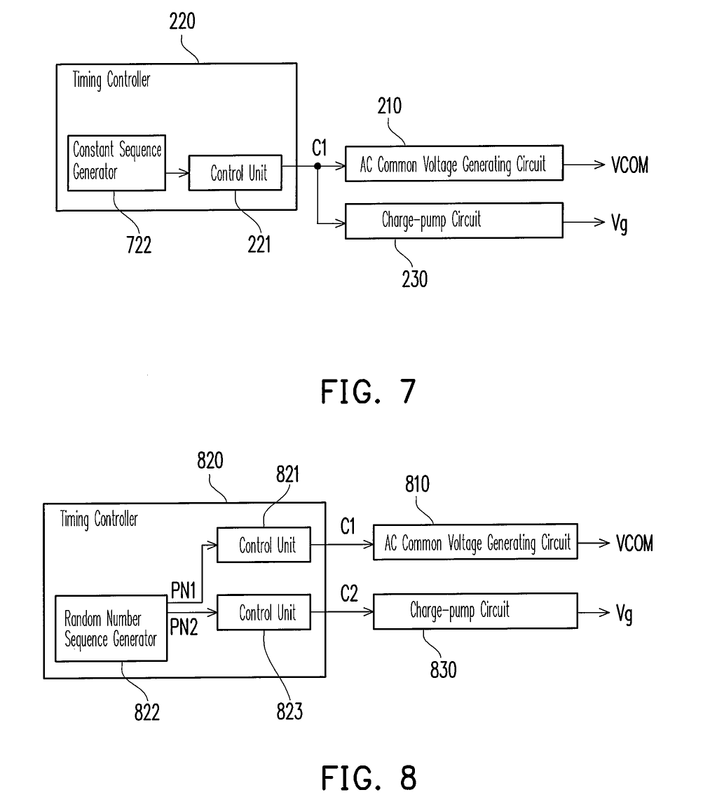

FIG. 7 is a block diagram of a voltage generating system according to a second embodiment of the present invention. In this embodiment, the present invention adopts a fixed sequence generator 722 to replace the random number sequence generator 222 in FIG. 2. The principle thereof has already been disclosed above, and can be understood and implemented by persons of ordinary skill in the art, which thus will not be repeated herein.

FIG. 8 is a block diagram of a voltage generating system according to a third embodiment of the present invention. In this embodiment, the random number sequence generator 822 outputs different random number sequences PN1 and PN2 respectively to different control units 821 and 823, and thus the control units 821 and 823 generate different control signals C1 and C2 according to the random number sequences PN1 and PN2. Therefore, the AC common voltage VCOM generated by the AC common voltage generating circuit 810 and the charge-pump circuit 830 has a time sequence different from that of the internal switching voltage used by the charge-pump circuit 830 for generating the predetermined voltage Vg.

The above design aims at dispersing the time point for the transition of the AC common voltage VCOM and the internal switching voltage used by the charge-pump circuit 830 for generating the predetermined voltage Vg, such that the energy of the transition of the AC common voltage VCOM and that of the internal switching voltage of the charge-pump circuit 830 do not fall within the same frequency at the same time, so as to further disperse the energy, thereby reducing the audio-frequency noises.

Moreover, when the charge-pump circuit 830 is turned off (e.g., the display driving apparatus utilizes an external power source), the control unit 823 may be turned off independently. In contrast, when the AC common voltage generating circuit 810 is turned off (e.g., when the display panel is not illuminated, but other elements in the display driving apparatus are still working), the control unit 821 may also be turned off independently, so as to save power.

The above design is not difficult for persons of ordinary skill in the art to make implementations. For example, taking the LFSR 600 in FIG. 6 for an example, generally, each bit in a 4-bit random number is respectively combined by four outputs of the shift registers 610, 620, 630, and 640. In other words, the four outputs of the shift registers 610, 620, 630, and 640 should be permuted and combined to obtain many different types of 4-bit random number data. Therefore, based on the above principle, persons skilled in the art may couple the control units 821 and 823 to different nodes of the LFSR 600 for receiving different random number sequences PN1 and PN2, so as to disperse the time point for the transition of the AC common voltage VCOM and the internal switching voltage of the charge-pump circuit 830.

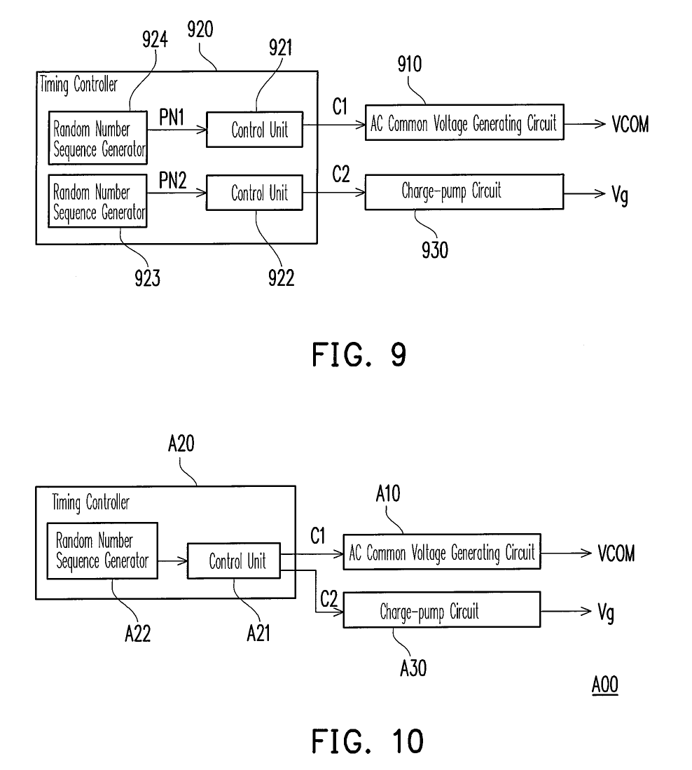

FIG. 9 is a block diagram of a voltage generating system according to a fourth embodiment of the present invention. In this embodiment, two random number sequence generators 923 and 924 are adopted to output different random number sequences PN1 and PN2 respectively to the control units 921 and 922. Therefore, the control units 921 and 922 generate different control signals C1 and C2 according to the random number sequences PN1 and PN2, and thus, the AC common voltage VCOM generated by the AC common voltage generating circuit 910 and the charge-pump circuit 930 has a time sequence somewhat different from the internal switching voltage used by the charge-pump circuit 830 for generating the predetermined voltage Vg, so as to disperse the time point for the transition of the AC common voltage VCOM and the internal switching voltage of the charge-pump circuit 930, thus further reducing the audio-frequency noises.

FIG. 10 is a block diagram of a voltage generating system according to a fifth embodiment of the present invention. The voltage generating system A00 includes an AC common voltage generating circuit A10, a timing controller A20, and a charge-pump circuit A30. The timing controller A20 includes a control unit A21 and a random number sequence generator A22, the AC common voltage generating circuit A10 generates the AC common voltage VCOM, and the charge-pump circuit A30 generates the predetermined voltage Vg.

It should be noted that, in the fifth embodiment, the control unit A21 respectively generates two different groups of control signal C1 and control signal C2. The AC common voltage generating circuit A10 and the charge-pump circuit A30 respectively receive the control signal C1 and the control signal C2 for being used by the AC common voltage generating circuit A10 and the charge-pump circuit A30. Such a manner is more effective than the voltage generating system 200 mentioned in the first embodiment. In addition, this mechanism is not difficult for persons of ordinary skill in the art to make implementations. For example, the control unit A21 generates the control signal C1 according to the random number sequence, and generates the control signal C2 through shifting the phase of the control signal C1. The above generating mechanism still falls within the scope of the present invention.

Compared with the conventional art, the voltage generating system of the present invention is capable of effectively reducing the noises brought about by audio-frequency noises. Therefore, when the electronic devices (such as digital cameras, PDAs) using the voltage generating devices of the present invention are used for video recording, they will not be influenced by the noises.

What is claimed is:

1. A voltage generating system, applicable for a display driving apparatus, the voltage generating system comprising:
a first control unit, for generating a first control signal, and changing at least one time point at which the first control signal performs transition, so as to dynamically adjust a frequency of the first control signal; and
an AC common voltage generating circuit, coupled to the first control unit, for generating an AC common voltage according to the first control signal.

2. The voltage generating system according to claim 1, wherein when the display driving apparatus is in a vertical active region, the time point at which the first control signal performs transition is changed within a gate-off region of a scan line.

3. The voltage generating system according to claim 1, wherein when the display driving apparatus is in a vertical blanking region, the time point at which the first control signal performs transition is changed arbitrarily.

4. The voltage generating system according to claim 1, wherein the first control unit generates the first control signal according to a sequence.

5. The voltage generating system according to claim 4, further comprising:
a sequence generator, coupled to the first control unit, for generating the sequence.

6. The voltage generating system according to claim 5, wherein the sequence is a random number sequence; and the sequence generator is a random number sequence generator.

7. The voltage generating system according to claim 6, wherein the sequence is formed by a plurality of code signals, any one of the plurality of code signals comprises a direction bit and at least one time bit, the first control unit delays or advances the time point according to the direction bit, and decides an extent to which the time point is delayed or advanced according to the time bit in the code signal.

8. The voltage generating system according to claim 7, wherein when the display driving apparatus is in the vertical active region, a code signal outputted by the random number sequence generator has a first bit number; when the display driving apparatus is in the vertical blanking region, a code signal outputted by the random number sequence generator has a second bit number larger than the first bit number.

9. The voltage generating system according to claim 5, wherein the first control unit and the sequence generator are disposed in a timing controller.

10. The voltage generating system according to claim 1, further comprising:
a charge-pump circuit, coupled to the first control unit, for generating a predetermined voltage according to the first control signal.

11. The voltage generating system according to claim 1, wherein the first control unit is further used to generate a second control signal, and the voltage generating system further comprises:
a charge-pump circuit, coupled to the first control unit, for generating a predetermined voltage according to the second control signal.

12. The voltage generating system according to claim 11, wherein the first control unit changes at least one time point at which the second control signal performs transition, so as to adjust a frequency of the second control signal dynamically.

13. The voltage generating system according to claim 11, wherein the first control unit generates the second control signal by shifting a phase of the first control signal.

14. The voltage generating system according to claim 1, further comprising:
a second control unit, for generating a second control signal, and changing at least one time point at which the second control signal performs transition, so as to dynamically adjust a frequency of the second control signal; and
a charge-pump circuit, coupled to the second control unit, for generating a predetermined voltage according to the second control signal.

15. The voltage generating system according to claim 14, wherein the first control unit and the second control unit are turned on or off individually.

16. The voltage generating system according to claim 14, wherein the first control unit and the second control unit are disposed in a timing controller.

17. The voltage generating system according to claim 14, wherein the first control unit generates the first control signal according to a first sequence, and the second control unit generates the second control signal according to a second sequence.

18. The voltage generating system according to claim 17, further comprising:
a sequence generator, coupled to the first control unit and the second control unit, for generating the first sequence and the second sequence.

19. The voltage generating system according to claim 18, wherein the first sequence and the second sequence are both random number sequences, and the sequence generator is a random number sequence generator.

20. The voltage generating system according to claim 17, further comprising:
a first sequence generator, coupled to the first control unit, for generating the first sequence; and
a second sequence generator, coupled to the second control unit, for generating the second sequence.

21. The voltage generating system according to claim 20, wherein the first sequence and the second sequence are both random number sequences, and the first sequence generator and the second sequence generator are both random number sequence generators.

22. A voltage generating system, applicable for a display driving apparatus, the voltage generating system comprising:
a control unit, for generating a control signal, and dynamically adjusting a time point at which the control signal performs transition, so as to change a frequency of the control signal; and
a charge-pump circuit, coupled to the control unit, for generating a predetermined voltage according to the control signal.

23. The voltage generating system according to claim 22, wherein the control unit generates the control signal according to a sequence.

24. The voltage generating system according to claim 23, further comprising:
a sequence generator, coupled to the control unit, for generating the sequence.

25. The voltage generating system according to claim 24, wherein the sequence is a random number sequence; and the sequence generator is a random number sequence generator.

26. The voltage generating system according to claim 25, wherein the sequence is formed by a plurality of code signals, any one of the plurality of code signals comprises a direction bit and at least one time bit, the control unit delays or advances the time point according to the direction bit, and decides an extent to which the time point is delayed or advanced according to the time bit in the code signal.

27. The voltage generating system according to claim 26, wherein when the display driving apparatus is in a vertical active region, a code signal outputted by the random number sequence generator has a first bit number; when the display driving apparatus is in a vertical blanking region, a code signal outputted by the random number sequence generator has a second bit number larger than the first bit number.

28. The voltage generating system according to claim 22, wherein the control unit and the sequence generator are disposed in a timing controller.
